(19) United States
(12) Patent Application Publication
(10) Pub. No.: US 2003/0040455 A1
(43) Pub. Date: Feb. 27, 2003

(54) Process for removal of excess disperse dye from printed or dyed textile material

(76) Inventors: Caroline Shi, Raleigh, NC (US); Henrik Lund, Skodsborg (DK); Uwe Vogt, Monheim (DE)

Correspondence Address: NOVOZYMES NORTH AMERICA, INC., 500 FIFTH AVENUE, SUITE 1600, NEW YORK, NY, 10110, US

(21) Appl. No.: 09/857,984

(22) PCT Filed: Dec. 22, 2000
(86) PCT No.: PCT/DK00/00724

(30) Foreign Application Priority Data
Dec. 23, 1999 (DK) PA 1999 01854

(51) Int. Cl. C11D 3/00

(52) U.S. Cl. 510/392

(57) ABSTRACT

The present invention provides a process for removal of excess disperse dye from printed or dyed textile material, comprising treatment with a rinse liquor comprising at least one enzyme selected from the group consisting of enzymes exhibiting peroxidase activity or laccase activity, an oxidation agent, and at least one mediator.

### FIELD OF THE INVENTION

The present invention relates to a method for removing excess disperse dye from dyed or printed textile material.

### BACKGROUND OF THE INVENTION

Dyeing of textiles with disperse dyes is carried out by applying the dyes to the textile by any appropriate method for binding the dyestuff to the fibres of the textiles. Disperse dyes are nonionic and have very limited solubility in water. The need for a post-dyeing clearing treatment (removal of excess dye) in disperse dyeing relates to the tendency of disperse dyes to aggregate and deposit at the surface of the fibre. If not removed, this surface contamination can undermine the brightness of the shade as well as the wash, sublimation and crockfastness results. The conventional treatment is a harsh reduction clearing, where the dyed fibre is treated in a strong alkaline reducing bath, usually made up of sodium hydrosulfite and caustic soda. Anthraquinone-based dyes are not fully destroyed by such a treatment, and such insufficient clearing often leads to particular poor wash fastness properties.

WO 92/18687 discloses a method of bleaching excess dye from fabric by treating with a liquor containing a peroxidase or oxidase enzyme, an O₂ or H₂O₂ source, and optionally an oxidizable substrate.

WO 99/34054 discloses a method of bleaching excess dye from fabric or yarn by treating with a liquor comprising a peroxidase or oxidase enzyme, an oxidation agent, and a N—OH mediator.

It is an object of the present invention to provide an efficient method for post-dyeing clearing of excess disperse dye from dyed textiles.

### SUMMARY OF THE INVENTION

The present invention relates to a process for removal of excess disperse dye from printed or dyed textile material comprising treatment with a rinse liquor comprising:

at least one enzyme selected from the group consisting of enzymes exhibiting peroxidase activity or laccase activity,

an oxidation agent, and

at least one mediator,

wherein the textile material is a fabric, yarn, fiber, garment or film which comprise at least 20% of a synthetic material.

Another aspect of the present invention is the use of the components specified above for the preparation of a multi-component system for removal of excess disperse dye from dyed or printed textile material.

### DETAILED DESCRIPTION OF THE INVENTION

The term “mediator” as used herein is intended to mean an oxidizable substance improving the enzymatic oxidative or bleaching effect. Mediators are also referred to as enhancing agents.

Textile Materials

The process of the invention is applicable to all types of textile materials—such as a fabric, yarn, fiber, garment or film—made from synthetic materials, and blends of natural and synthetic materials. Preferably blends of natural and synthetic materials comprise at least 20%, more preferably at least 40%, even more preferably at least 60%, most preferably at least 80%, and in particular at least 95% of a synthetic material. Typical examples of synthetic materials are modified cellulose (e.g. acetate diacetate and triacetate), polyamide (e.g. nylon 6 and 6,6), polyester (e.g. poly(ethylene terephthalate)), acrylic/polyacrylic, and polyurethane (e.g. spandex). Typical examples of natural materials are regenerated cellulosics (e.g.rayon), solvent spun cellulosics (e.g. lyocel and tencel), natural cellulosics (e.g. cotton, flax, linen, and ramie) and proteins (e.g. wool and silk). The term “synthetic” as used herein is intended to mean non-naturally occuring or man-made.

The process of the invention may be applied to dyed yarn, to knitted, woven or non-woven fabric, or to garments made from dyed and/or printed fabric.

Dyes

The process of the invention is used for oxidative removal or bleaching of excess disperse dyes after any kind of disperse dyeing or printing. The process is also referred to as a clearing process. Oxidative removal includes modifying or degrading the excess disperse dye molecules; or changing the colour of the dye, such as whitening or fading (bleaching) the color of the dye.

Disperse dyes are characterised by being nonionic and have a very limited solubility in water. Disperse dyes include azo, nitroarylamine, and anthraquinone based dyes. Examples of disperse dyes include Disperse Red 60, Disperse Yellow 3, Disperse Blue 3, Disperse Blue 27, Disperse Blue 56, and Disperse Violet 1.

Enzyme

Enzymes exhibiting peroxidase activity or laccase activity are those, which by using hydrogen peroxide or molecular oxygen respectively are capable of oxidising a variety of compounds, such as phenols and aromatic amines.

According to the invention the concentration of enzyme is 0.005 to 10 mg enzyme protein per liter of rinse liquor, preferably, 0.02 to 5 mg enzyme protein per liter of rinse liquor, more preferably 0.05 to 2 mg enzyme protein per liter of rinse liquor. According to the liquor ratio, this may be translated to dosages of enzyme per kg of textile material, e.g. at a liquor ratio of 10:1, the most preferred enzyme dosage is from 0.5 to 20 mg enzyme per kg of textile material.

Peroxidase Activity Exhibiting Enzymes

An enzyme exhibiting peroxidase activity may be any peroxidase comprised by the enzyme classification (EC 1.11.1.7), or a haloperoxidase, such as a chloride peroxidase (EC 1.11.1.10) or any fragment or synthetic or semisynthetic derivatives thereof exhibiting enzymatic activity (e.g. porphyrin ring systems or micro-peroxidases, cf. e.g. U.S. Pat. No. 4,077,768, EP 537 381, WO 91/05858 and WO 92/16634). Such enzymes are known from microbial, plant and animal origins.

Preferably, the peroxidase employed in the method of the invention is producible by plants (e.g. horseradish or soybean peroxidase), in particular soybean peroxidase, or by microorganisms, such as fungi (including filamentous fungi and yeasts) or bacteria.

Some preferred fungi include strains belonging to the subdivision Deuteromycotina class Hyphomycetes, e.g., Fusarium, Humicola, Tricoderma, Myrothecium, Verticillum, Arthromyces, Caldariomyces, Ulocladium, Embellisia, Cladosporium or Dreschlera, in particular Fusarium oxysporum (DSM 2672), Humicola insolens, Trichoderma resii, Myrothecium verrucana (IFO 6113), Verticillum alboatrum, Verticillum dahlie, Arthromyces ramosus (FERM P-7754), Caldariomyces fumago, Ulocladium chartarum, Embellisia alli or Dreschlera halodes.

Other preferred fungi include strains belonging to the subdivision Basidiomy-cotina, class Basidiomycetes, e.g. Coprinus, Phanerochaete, Coriolus or Trametes, in particular Coprinus cinereus f. microsporus (IFO 8371), Coprinus macrorhizus, Phanerochaete chrysosporium (e.g. NA-12) or Trametes (some classes previously called Polyporus have been renamed to Trametes), e.g., T. versicolor (e.g. PR4 28-A).

Further preferred fungi include strains belonging to the subdivision Zygomy-cotina, class Mycoraceae, e.g. Rhizopus or Mucor, in particular Mucor hiemalis.

Some preferred bacteria include strains of the order Actinomycetales, e.g., Streptomyces spheroides (ATTC 23965), Streptomyces thermoviolaceus (IFO 12382) or Streptoverticillum verticillium ssp. verticillium.

Other preferred bacteria include Bacillus pumilus (ATCC 12905), Bacillus stearothermophilus, Rhodobacter sphaeroides, Rhodomonas palustri, Streptococcus lactis, Pseudomonas purrocinia (ATCC 15958) or Pseudomonas fluorescens (NRRL B-11).

Further preferred bacteria include strains belonging to Myxococcus, e.g., M. virescens.

The peroxidase may furthermore be one which is producible by a method comprising cultivating a host cell transformed with a recombinant DNA vector which carries a DNA sequence encoding said peroxidase as well as DNA sequences encoding functions permitting the expression of the DNA sequence encoding the peroxidase, in a culture medium under conditions permitting the expression of the peroxidase, and recovering the peroxidase from the culture.

Particularly, a recombinantly produced peroxidase is a peroxidase derived from a Coprinus sp., in particular C. macrorhizus or C. cinereus according to WO 92/16634, or a variant thereof.

In the context of this invention, peroxidase acting compounds comprise peroxidase active fragments derived from cytochromes, hemoglobin or peroxidase enzymes, and synthetic or semisynthetic derivatives thereof, e.g. iron complexes of porphyrin or phthalocyanine and derivatives thereof.

Laccase and Laccase Related Enzymes

In the context of this invention, the term “enzymes exhibiting laccase activity” means laccases and laccase related enzymes, such as any laccase comprised by the enzyme classification (EC 1.10.3.2), any catechol oxidase comprised by the enzyme classification (EC 1.10.3.1), any bilirubin oxidase comprised by the enzyme classification (EC 1.3.3.5) or any monophenol monooxygenase comprised by the enzyme classification (EC 1.14.18.1).

The laccases are known from microbial and plant origin. The microbial laccases may be derived from bacteria or fungi (including filamentous fungi and yeasts) and suitable examples include a laccase derivable from a strain of Aspergillus, Neurospora, e.g., N. crassa, Podospora, Botrytis, Collybia, Fomes, Lentinus, Pleurotus, Trametes (Polyporus), e.g., T. villosa, T. versicolor and T. pinsitus, Rhizoctonia, e.g., R. solani, Coprinus, e.g. C. plicatilis and C. cinereus, Psatyrella, Myceliophthora, e.g. M. thermophila, Schytalidium, Phlebia, e.g., P. radiata (WO 92/01046), or Coriolus, e.g., C. hirsutus (JP 2-238885), in particular a laccase derivable from a strain of Fomes, Trametes (Polyporus), Rhizoctonia, Coprinus, Myceliophthora, or Schytalidium.

The laccase or the laccase related enzyme may furthermore be one which is producible by a method comprising cultivating a host cell transformed with a recombinant DNA vector which carries a DNA sequence encoding said laccase as well as DNA sequences encoding functions permitting the expression of the DNA sequence encoding the laccase, in a culture medium under conditions permitting the expression of the laccase, and recovering the laccase from the culture.

Oxidation Agent

If the oxidizing enzyme requires a source of hydrogen peroxide, the source may be hydrogen peroxide or a hydrogen peroxide precursor for in situ production of hydrogen peroxide, e.g., a percarbonate or a perborate, a persulfate, such as a trioxo (peroxo)sulfate or a μ-peroxo-bis(trioxosulfate), a hydrogen peroxide-urea addition compound, a peroxycarboxylic acid or a salt thereof or a hydrogen peroxide generating enzyme system, e.g., an oxidase and a substrate for the oxidase, e.g. an amino acid oxidase and a suitable amino acid.

Hydrogen peroxide may be added at the beginning of or during the process, e.g., in a concentration corresponding to 0.01-50 mM H₂O₂, preferably 0.1 to 5 mM.

If the oxidizing enzyme requires molecular oxygen, molecular oxygen from the atmosphere will usually be present in sufficient quantity. Otherwise pure O₂ may be led to the rinse liquor, or an O₂ generating enzymatic system, e.g. a system based on hydrogen peroxide and a catalase, may be added.

Mediator

According to the invention the textile material is treated with a solution or rinse liquor comprising at least one mediator.

The mediators may be selected from the group consisting of aliphatic, cyclo-aliphatic, heterocyclic or aromatic compounds containing the moiety >N—OH. In a preferred embodiment of the invention the mediator is a compound of the general formula I:

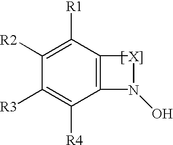

wherein R¹, R², R³, R⁴ are individually selected from the group consisting of hydrogen halogen, hydroxy, formyl, carboxy and salts and esters thereof, amino, nitro, C₁₋₁₂-alkyl, C₁₋₆-alkoxy, acyl, aryl, in particular phenyl, sulfo, aminosulfonyl, carbamoyl, phosphono, phosphonooxy, and salts and esters thereof, wherein the R¹, R², R³, R⁴ may be substituted with R⁵, wherein R⁵ represents hydrogen, halogen, hydroxy, formyl carboxy and salts and esters thereof, amino, nitro, C₁₋₁₂-alkyl, C₁₋₆-alkoxy, acyl, aryl, in particular phenyl, sulfo, aminosulfonyl, carbamoyl, phosphono, phosphonooxy, and salts and esters thereof;

[X] represents a group selected from (—N═N—), (—N═CR⁶—)ₘ, (—CR⁶═N—)ₘ, (—CR⁷═CR⁸—)ₘ, (—CR⁶═N—NR⁷—), (—N═N—CHR⁶—), (—N═CR⁶—NR⁷—), (—N═CR⁶—CHR⁷—), (—CR⁶═N—CHR⁷—), (—CR⁶═CR⁷—NR⁸—), and (—CR⁶═CR⁷—CHR⁸—), wherein R⁶, R⁷, and R⁸ independently of each other are selected from H, OH, NH₂, COOH, SO₃H, C₁₋₆-alkyl, NO₂, CN, Cl, Br, F, CH₂OCH₃, OCH₃, and COOCH₃; and m is 1 or 2.

In a more preferred embodiment of the invention the mediator is a compound of the general formula II:

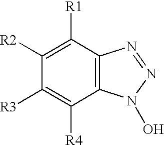

wherein R¹, R², R³, R⁴ are individually selected from the group consisting of hydrogen halogen, hydroxy, formyl, carboxy and salts and esters thereof, amino, nitro, C₁₋₁₂-alkyl, C₁₋₆-alkoxy, acyl, aryl, in particular phenyl, sulfo, aminosulfonyl, carbamoyl, phosphono, phosphonooxy, and salts and esters thereof, wherein the R¹, R², R³, R⁴ may be substituted with R⁵, wherein R⁵ represents hydrogen, halogen, hydroxy, formyl, carboxy and salts and esters thereof, amino, nitro, C₁₋₁₂-alkyl, C₁₋₆-alkoxy, acyl, aryl, in particular phenyl, sulfo, aminosulfonyl, carbamoyl, phosphono, phosphonooxy, and salts and esters thereof.

The mediator may also be a salt or an ester of formula I or II.

Further preferred mediators are oxoderivatives and N-hydroxy derivatives of heterocyclic compounds and oximes of oxo- and formyl-derivatives of heterocyclic compounds, said heterocyclic compounds including five-membered nitrogen-containing heterocycles, in particular pyrrol, pyrazole and imidazole and their hydrogenated counterparts (e.g. pyrrolidine) as well as triazoles, such as 1,2,4-triazole; six-membered nitrogen-containing heterocycles, in particular mono-, di- and triazinanes (such as piperidine and piperazine), morpholine and their unsaturated counterparts (e.g. pyridine and pyrimidine); and condensed heterocycles containing the above heterocycles as substructures, e.g. indole, benzothiazole, quinoline and benzoazepine.

Examples of preferred mediators from these classes of compounds are pyridine aldoximes; N-hydroxypyrrolidinediones such as N-hydroxysuccinimide and N-hydroxyphthalimide; 3,4-dihydro-3-hydroxybenzo[1,2,3]triazine-4-one; formaldoxime trimer (N,N′,N″-trihydroxy-1,3,5-triazinane); and violuric acid (1,3-diazinane-2,4,5,6-tetrone-5-oxime).

Still further mediators which may be applied in the invention include oximes of oxo- and formyl-derivatives of aromatic compounds, such as benzoquinone dioxime and salicylaldoxime (2-hydroxybenzaldehyde oxime), and N-hydroxyamides and N-hydroxyanilides, such as N-hydroxyacetanilide.

Preferred mediators are selected from the group consisting of 1-hydroxybenzotriazole; 1-hydroxybenzotriazole hydrate; 1-hydroxybenzotriazole sodium salt; 1-hydroxybenzotriazole potassium salt; 1-hydroxybenzotriazole lithium salt; 1-hydroxybenzotriazole ammonium salt; 1-hydroxybenzotriazole calcium salt; 1-hydroxybenzotriazole magnesium salt; and 1-hydroxybenzotriazole-6-sulphonic acid.

A particularly preferred mediator is 1-hydroxybenzotriazole.

All the specifications of N-hydroxy compounds above are understood to include tautomeric forms such as N-oxides whenever relevant.

Another preferred group of mediators comprises a —CO—NOH— group and has the general formula III:

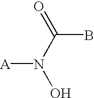

in which A and B independently of each other are:

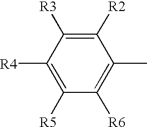

or B is H or C₁₋₁₂-alkyl, said alkyl may contain hydroxy, ester or ether groups (e.g. wherein the ether oxygen is directly attached to A—N(OH)C═O—, thus including N-hydroxy carbamic acid ester derivatives), and R2, R3, R4, R5 and R6 independently of each other are H, OH, NH₂, COOH, SO₃H, C₁₋₈-alkyl, acyl, NO₂, CN, Cl, Br, F, CF₃, NOH—CO-phenyl, CO—NOH-phenyl, C₁₋₆-CO—NOH—A, CO—NOH—A, COR12, phenyl-CO—NOH—A, OR7, NR8R9, COOR10, or NOH—CO—R11, wherein R7, R8, R9, R10, R 11 and R12 are C₁₋₁₂-alkyl or acyl.

R2, R3, R4, R5 and R6 of A are preferably H, OH, NH₂, COOH, SO₃H, C₁₋₃-alkyl, acyl, NO₂, CN, Cl, Br, F, CF₃, NOH—CO-phenyl, CO—NOH-phenyl, COR12, OR7, NR8R9, COOR10, or NOH—CO—R11, wherein R7, R8 and R9 are C₁₋₃-alkyl or acyl, and R10, R1 and R12 are C₁₋₃-alkyl; more preferably R2, R3, R4, R5 and R6 of A are H, OH, NH₂, COOH, SO₃H, CH₃, acyl, NO₂, CN, Cl, Br, F, CF₃, CO—NOH-phenyl, COCH₃, OR7, NR8R9, or COOCH₃, wherein R7, R8 and R9 and CH₃ or COCH₃; even more preferably R2, R3, R4, R5 and R6 of A are H, OH, COOH, SO₃H, CH₃, acyl, NO₂, CN, Cl, Br, F, CO—NOH-phenyl, OCH₃, COCH₃, or COOCH₃; and in particular R2, R3, R4, R5 and R6 of A are H, OH, COOH, SO₃H, CH₃, NO₂, CN, Cl, Br, CO—NOH-phenyl, or OCH₃.

R2, R3, R4, R5 and R6 of B are preferably H, OH, NH₂, COOH, SO₃H, C₁₋₃-alkyl, acyl, NO₂, CN, Cl, Br, F, CF₃, NOH—CO-phenyl, CO—NOH-phenyl, COR12, OR7, NR8R9, COOR10, or NOH—CO—R11, wherein R7, R8 and R9 are C₁₋₃-alkyl or acyl, and R10, R11 and R12 are C₁₋₃-alkyl; more preferably R2, R3, R4, R5 and R6 of B are H, OH, NH₂, COOH, SO₃H, CH₃, acyl, NO₂, CN, Cl, Br, F, CF₃, CO—NOH-phenyl, COCH₃, OR7, NR8R9, or COOCH₃, wherein R7, R8 and R9 are CH₃ or COCH₃; even more preferably R2, R3, R4, R5 and R6 of B are H, OH, COOH, SO₃H, CH₃, acyl, NO₂, CN, Cl, Br, F, CO—NOH-phenyl, OCH₃, COCH₃, or COOCH₃; and in particular R2, R3, R4, R5 and R6 of B are H, OH, COOH, SO₃H, CH₃, NO₂, CN, Cl, Br, CO—NOH-phenyl, or OCH₃.

B is preferably H or C₁₋₃-alkyl, said alkyl may contain hydroxy, ester or ether groups; preferably said alkyl may contain ester or ether groups; more preferably said alkyl may contain ether groups.

In an embodiment, A and B independently of each other are:

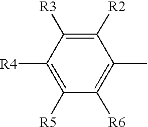

or B is H or C ₁₋₃-alkyl, said alkyl may contain hydroxy, ester or ether groups (e.g wherein the ether oxygen is directly attached to A—N(OH)C═O—, thus including N-hydroxy carbamic acid ester derivatives), and R2, R3, R4, R5 and R6 independently of each other are H, OH, NH₂, COOH, SO₃H, C₁₋₃-alkyl, acyl, NO₂, CN, Cl, Br, F, CF₃, NOH—CO-phenyl, CO—NOH-phenyl, COR12, OR7, NR8R9, COOR10, or NOH—CO—R11, wherein R7, R8 and R9 are C₁₋₃-alkyl or acyl, and R10, R11 and R12 are C₁₋₃-alkyl.

In another embodiment, A and B independently of each other are:

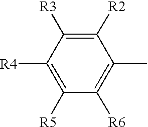

or B is H or C₁₋₃-alkyl, said alkyl may contain hydroxy or ether groups (e.g. wherein the ether oxygen is directly attached to A—N(OH)C═O—, thus including N-hydroxy carbamic acid ester derivatives), and R2, R3, R4, R5 and R6 independently of each other are H, OH, NH₂, COOH, SO₃H, CH₃, acyl, NO₂, CN, Cl, Br, F, CF₃, CO—NOH-phenyl, COCH₃, OR7, NR8R9, or COOCH₃, wherein R7, R8 and R9 are CH₃ or COCH₃.

In another embodiment, A and B independently of each other are:

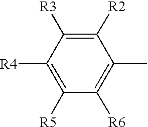

or B is H or C₁₋₃-alkyl, said alkyl may contain hydroxy or ether groups (e.g. wherein the ether oxygen is directly attached to A—N(OH)C═O—, thus including N-hydroxy carbamic acid ester derivatives), and R2, R3, R4, R5 and R6 independently of each other are H, OH, COOH, SO₃H, CH₃, acyl, N₂, CN, Cl, Br, F, CO—NOH-phenyl, OCH₃, COCH₃, or COOCH₃.

In another embodiment, A and B independently of each other are:

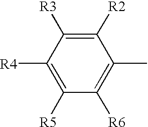

or B is C₁₋₃-alkyl, said alkyl may contain ether groups (e.g. wherein the ether oxygen is directly attached to A—N(OH)C═O—, thus including N-hydroxy carbamic acid ester derivatives), and R2, R3, R4, R5 and R6 independently of each other are H, OH, COOH, SO₃H, CH₃, NO₂, CN, Cl, Br, CO—NOH-phenyl, or OCH₃.

In an embodiment at least one of the substituents R2, R3, R4, R5 and R6 of A are H, preferably at least two of the substituents R2, R3, R4, R5 and R6 of A are H, more preferably at least three of the substituents R2, R3, R4, R5 and R6 of A are H, most preferably at least four of the substituents R2, R3, R4, R5 and R6 of A are H, in particular all of R2, R3. R4, R5 and R6 of A are H.

In another embodiment at least one of the substituents R2, R3, R4, R5 and R6 of B are H, preferably at least two of the substituents R2, R3, R4, R5 and R6 of B are H, more preferably at least three of the substituents R2, R3, R4, R5 and R6 of B are H, most preferably at least four of the substituents R2, R3, R4, R5 and R6 of B are H, in particular all of R2, R3, R4, R5 and R6 of B are H.

In particular embodiments according to the invention the enhancing agent is selected from the group consisting of

4-nitrobenzoic acid-N-hydroxyanilide;

4-methoxybenzoic acid-N-hydroxyanilide;

N,N′-dihydroxy-N,N′-diphenylterephthalamide;

decanoic acid-N-hydroxyanilide;

N-hydroxy-4-cyanoacetanilide;

N-hydroxy-4-acetylacetanilide;

N-hydroxy-4-hydroxyacetanilide:

N-hydroxy-3-(N′-hydroxyacetamide)acetanilide;

4-cyanobenzoic acid-N-hydroxyanilide;

N-hydroxy-4-nitroacetanilide;

N-hydroxyacetanilide;

N-hydroxy-N-phenyl-carbamic acid isopropyl ester;

N-hydroxy-N-phenyl-carbamic acid methyl ester;

N-hydroxy-N-phenyl-carbamic acid phenyl ester;

N-hydroxy-N-phenyl-carbamic acid ethyl ester; and

N-hydroxy-N-(4-cyanophenyl)-carbamic acid methyl ester.

Another group of preferred mediators is phenolic compounds (alkylsyringates) of the general formula IV:

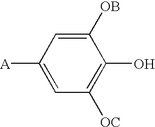

wherein A represents any of the following groups: (—D), (—CH═CH—D), (—CH═CH—CH═CH—D), (—CH═N—D), (—N═N—D), or (—N═CH—D); in which D is selected from the group consisting of —CO—E, —SO₂—E, —N—XY, and —N⁺—XYZ; in which E may be —H, —OH, —R, or —OR; and X and Y and Z may be identical or different and selected from —H and —R; wherein R is a C₁₋₁₂-alkyl, preferably a C₁₋₈-alkyl, which alkyl may be substituted with a carboxy, sulpho or amino group; and B and C may be the same or different and selected from C₁₋₅-alkyl.

In general formula IV, A may be placed meta to the hydroxy group instead of being placed in the para-position as shown.

In particular embodiments of the invention the mediator is selected from the group having the general formula V:

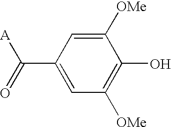

in which A represents any of the following radicals: H, OH, CH₃, OCH₃, C₁₋₁₂-alkoxy.

Yet another group of preferred mediators are the compounds as described by general formula VI:

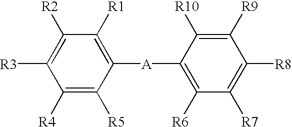

in which general formula A represents a single bond, or one of the following groups: (—CH₂—), (—CH═CH—), (—NR11—), (—CH═N—), (—N═N—), (—CH═N—N═CH—), or (>C═O);

and in which general formula the substituent groups R1-R11, which may be identical or different, independently represents any of the following radicals: hydrogen, halogen, hydroxy, formyl, acetyl, carboxy and esters and salts hereof, carbamoyl, sulfo and esters and salts hereof, sulfamoyl, methoxy, nitro, amino, phenyl, C₁₋₈-alkyl;

which carbamoyl, sulfamoyl, phenyl, and amino groups may furthermore be unsubstituted or substituted once or twice with a substituent group R12; and which C₁₋₈-alkyl group may be unsubstituted or substituted with one or more substituent groups R12;

which substituent group R12 represents any of the following radicals: hydrogen, halogen, hydroxy, formyl, acetyl, carboxy and esters and salts hereof, carbamoyl, sulfo and esters and salts hereof, sulfamoyl, methoxy, nitro, amino, phenyl, or C₁₋₈-alkyl; which carbamoyl, sulfamoyl, and amino groups may furthermore be unsubstituted or substituted once or twice with hydroxy or methyl.

and in which general formula R5 and R6 may together form a group -B-, in which B represents a single bond, one of the following groups (—CH₂—), (—CH═CH—), (—CH═N—); or B represents sulfur, or oxygen.

In particular embodiments of the invention the mediator is selected from the group having the general formula VII:

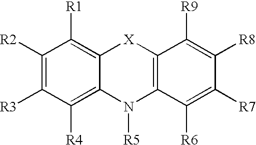

in which general formula X represents a single bond, oxygen, or sulphur;

and in which general formula the substituent groups R1-R9, which may be identical or different, independently represents any of the following radicals: hydrogen, halogen, hydroxy, formyl, acetyl, carboxy and esters and salts hereof, carbamoyl, sulfo and esters and salts hereof, sulfamoyl, methoxy, nitro, amino, phenyl, C₁₋₈-alkyl;

which carbamoyl, sulfamoyl, phenyl, and amino groups may furthermore be unsubstituted or substituted once or twice with a substituent group R10, and which C₁₋₈-alkyl group may be unsubstituted or substituted with one or more substituent groups R10;

which substituent group R10 represents any of the following radicals: hydrogen, halogen, hydroxy, formyl, acetyl, carboxy and esters and salts hereof, carbamoyl, sulfo and esters and salts hereof, sulfamoyl, methoxy, nitro, amino, phenyl, or C₁₋₈-alkyl; which carbamoyl, sulfamoyl, and amino groups may furthermore be unsubstituted or substituted once or twice with hydroxy or methyl.

The term “C₁₋ₙ-alkyl” wherein n can be from 2 through 12, as used herein, represents a saturated or unsaturated, and branched or straight alkyl group having from one to the specified number of carbon atoms (n); preferably the alkyl group is a saturated alkyl group. Typical C₁₋₆-alkyl groups include, but are not limited to, methyl, ethyl, ethenyl (vinyl), n-propyl, isopropyl, propenyl, isopropenyl, butyl, isobutyl, sec-butyl, tert-butyl, crotyl, methallyl, pentyl, isopentyl, propenyl, prenyl, hexyl, isohexyl, and the like.

The term “C₁₋ₙ-alkoxy” wherein n can be from 2 through 8, as used herein, represents a C₁₋ₙ-alkyl group linked through an ether group; such as methoxy, ethoxy, propoxy, isopropoxy, butoxy, isobutoxy, sec-butoxy, tert-butoxy, pentoxy, and the like.

The term “acyl” as used herein refers to a monovalent substituent comprising a C₁₋₈-alkyl group linked through a carbonyl group; such as acetyl, propionyl, butyryl, isobutyryl, pivaloyl, valeryl, and the like.

The term “halogen” as used herein represents a halogen substituent, such as flouride (F), chloride (Cl), bromide (Br), and iodide (I).

Usually, the concentration of the mediator in the rinse liquor is from 0.1 μM to 50 mM, preferably 0.5 μM to 10 mM, more preferably 1 μM to 1 mM, and most preferably 10 μM to 0.5 mM.

Additives

The rinse liquor may comprise further additives, such as wetting agents, surfactants and/or water conditioning agents.

Multi-Component System

In order to carry out the process described above a multi-component system is added to the solution (rinse liquor) used in at least one of the rinsing steps.

The components of the multi-component system may individually be in one of several product forms, such as a slurry, a solution or a granulate.

In one embodiment of the invention two components are mixed in the represented form, such as a co-granulate, a solution or a slurry comprising enzyme and mediator.

In cases of co-granulates, the co-granulate may comprise at least one enzyme and at least one mediator. Another example of a co-granulate is a granulate comprising at least two different enzymes and optionally at least one mediator.

In a further embodiment the system is a mixture of granulates wherein the component(s) in one granulate is(are) enzyme(s) and the component(s) in another granulate is(are) mediator(s).

According to the present invention a preferred multi-component system comprises at least one enzyme selected from the group consisting of enzymes exhibiting peroxidase activity or laccase activity, optionally an oxidation agent, and at least one mediator.

The enzymes exhibiting peroxidase activity or laccase activity are preferably as described above.

The system may comprise an oxidation agent, but in cases where the enzyme is an enzyme exhibiting laccase activity, molecular oxygen from the atmosphere is normally sufficient, and the system used will not comprise an oxidation agent. However, when the enzymes used require addition of an oxidation agent those are as described above. In all cases wherein a H₂O₂ source is the oxidation agent the enzyme and oxidation agent may not be mixed before use.

The system comprises at least one mediator. In a preferred embodiment, the mediator is described by general formulas I, II, III, IV, V, VI, and/or VII as shown above.

A further aspect of the present invention is the use of components comprising:

at least one enzyme selected from the group consisting of enzymes exhibiting peroxidase activity or laccase activity, and

optionally an oxidation agent, and

at least one mediator,

for the preparation of a multi-component system for removal of excess disperse dye or print from a dyed or printed textile material, wherein the textile material is a fabric, yarn, fiber, garment or film which comprise at least 20% of a synthetic material.

Process Conditions

The removal of excess disperse dye, according to the invention, may comprise rinsing with rinse liquor in one or more rinse steps. In an embodiment 1 to 6 rinse steps, more preferred in 1 to 4 rinse steps, even more preferred in 1 to 2 rinse steps, in particular in one rinse step is used. The number of rinse steps used depends on how the invention is practiced in an industrial process.

The multi-component system as defined according to this invention may be used in any of the rinse steps performed, however it is preferably added in the early rinse steps, in particular in the first, second and/or third rinse step.

The process of the invention may be carried out any time after the dyeing/rinsing process.

The process may be run in batch mode or continuous mode. The process may be applied on a winch, a beck, a jet dyer, an open-width washing machine, a J or U box, a steamer, or any other equipment available suitable for a rinsing process.

The process conditions must be chosen according to the characteristics of the enzyme in question. The temperature employed in the rinsing step(s) comprising a multi-component system as defined above is preferably ranging from 20° C. to 120° C., more preferably ranging from 30° C. to 80° C., most preferably ranging from 40° C. to 80° C., and in particular ranging from 50° C. to 70° C. The pH employed is typically in the range of pH 4-9.5, preferably in the range of pH 4-9, more preferably in the range of pH 4-8, most preferably in the range of pH 4.5-7, and in particular in the range of pH 5-6.5.

Fastness

Fastness (wash, crock, light, etc.) may be measured by various methods. Wash fastness may be measured as described below. Colour fastness to crocking, which is designed to determine the amount of colour transferred from the surface of coloured materials to other surfaces by rubbing, may be measured according to AATCC Test Method 8-1996. Colour fastness to light, in which samples of the material to be tested and the agreed upon comparison standard(s) are exposed simultaneously to a light source under specified conditions, may be measured according to AATCC Test Method 16-1993.

Removal of Excess Disperse Dye

The multi-component system as defined above is added to the rinsing liquor to remove excess disperse dye from the fabric surface.

The “Wash fastness” reflects the degree to which this has successfully been achieved.

In the present invention the wash fastness is measured by AATCC TM 61-2A, 1994. Briefly, in this method a dyed fabric is subjected to appropriate conditions of temperature, detergent solution, and abrasive action such that color change is similar to that occurring in five hand, home or commercial launderings. The swatches are evaluated for color change of the sample and staining on multi-fiber adjacent fabrics.

The degree of wash fastness is gauged with a scale; the higher number the better wash fastness. 1 means very low wash fastness, whereas 5 means very high wash fastness. The wash fastness obtained with the method of the invention is preferably at least 1.5, more preferably at least 2, and most preferably at least 2.5.

Colour Measurement

A HunterLab Labscan XE Spectrophotometer was used according to the manufacturer's instructions to evaluate the chromaticity using the change in the colour space coordinates L*a*b* (CIELAB-system), where as usual:

L* gives the change in white/black on a scale from 0 to 100, and a decrease in L* means an increase in black colour (decrease in white colour) and an increase in L* means an increase in white colour (decrease in black colour).

a* gives the change in red/green, and a decrease in a* means an increase in green colour (decrease in red colour), and an increase in a* means an increase in red colour (decrease in green colour).

b* gives the change in blue/yellow, and a decrease in b* means an increase in blue colour (decrease in yellow colour), and an increase in b* means an increase in yellow colour (decrease in blue colour) (Vide WO 96/12846 NOVO).

The HunterLab Labscan XE Spectrophotometer was operated in the L*a*b* colour space. The light source was D65 standard light. The software used for evaluation was Universal Software Version 3.5. This instrument has a ⁰° illumination /45° circumferential viewing optical geometry and was calibrated using the white and black tiles. Each result was an average of 8 measurements. Fabric rinsed without enzyme and mediator was measured and the coordinates L*a*b were calculated and entered as a reference. The coordinates of the samples were then for each of L*, a*, b* calculated as the difference of the average of the measurements on each swatch from the reference value.

Another color parameter, K/S, can also be obtained from the HunterLab Labscan K/S is calculated from the Kubelka-Munk equation as follows:

K/S=(1−R)²/2R

where:

K=absorption coefficient, depending on the concentration of the colorant;

S=scattering coefficient, often caused only by the substrate being dyed; and

R=reflectance factor (from 0 to 1).

This equation describes the relationship between reflection and the concentration of the colorants of the opaque reflecting samples. K/S values can be used to monitor the change in color strength of the dyed swatches treated with enzyme/mediator system versus that of the reference.

The present invention is further illustrated in the following examples, which are not in any way intended to limit the scope of the invention as claimed.

### EXAMPLES

The chemicals used in the following examples were commercial products of at least reagent grade.

### Example 1

Disperse Dyeing of Polyester Fabric Followed by an Enzymatic Clearing Process (POD/HOBT System)

Knitted, bleached 100% polyester was dyed in a Mathis Labomat machine (Werner Mathis U.S.A. Inc.) under the following conditions:

| | |
|---|---|
| Water: | softened water |
| Polyester fabric: | 20 g (100% Texturized Dacron 56 Double Knit—no |
| | heat set, supplied by Textile Innovators Corporation) |
| Liquor:fabric ratio: | 15:1 |
| Dyestuff: | 4% Disperse Violet 1 (Akasperse Violet 3R from |
| | Aakash Chemicals & Dyestuffs, Inc.) |
| EDTA: | 0.5 g/L (chelating agent) |
| Sodium acetate: | 2 g/L (dyebath pH control at 4-5) |

The dyeing process started by cold addition of EDTA, sodium acetate, dyestuff and fabric. The dyebath was pre-heated to 60° C. at 3.5° C./min and circulating for 10 minutes. Thereafter, the temperature was raised at 1.5° C./min to 130° C., where the dyeing process lasted 60 min.

Upon the completion of the dyeing process, the dyebath was rapidly cooled down to 70° C. followed by draining off the dyeing liquor, whereafter the afterclearing process was started.

The afterclearing process was conducted as follows:

Filling with 5 mM phosphate buffer (pH 7); 20 mL/g fabric.

Raising rinse bath temperature to 60° C.

Addition of 2 mL SP502 peroxidase stock (240 POXU/mL), 4 mL HOBT stock (10 mM) and 2 mL H₂O₂ stock (20 mM).

Rinsing 20 minutes at 60° C.

Draining the rinse liquor.

SP502 was a liquid preparation of recombinant Coprinus cinereous peroxidase supplied by Novozymes A/S (produced as described in WO 92/16634). HOBT was 1-hydroxybenzotriazole distributed by Sigma.

The fabric was squeezed and dried. The wash fastness was determined according to AATCC TM 61-2A, 1994. The staining evaluation scores were found to be 3.5 (silk), 2.5 (Nylon) and 2.0 (Acetate).

### Example 2

Disperse Dyeing of Polyester Fabric followed by Conventional Chemical Reduction Clearing

The dyeing process was carried out as described in Example 1. The afterclearing process was conducted as follows:

Addition of 2 g/L sodium hydroxide (or soda ash) and 2 g/L sodium hydrosulfite in fresh softened water; 20 mL/g fabric.

Raising rinse bath temperature to 70° C.

Rinsing 20 minutes at 70° C.

Draining the rinse liquor.

Refilling and neutralizing with 0.5-1 g/L acetic acid.

The fabric was squeezed and dried. The wash fastness was determined according to AATCC TM 61-2A, 1994. The staining evaluation scores were found to be 3.5 (silk), 2.0 (Nylon) and 2.5 (Acetate).

### Example 3

Disperse Dyeing of Polyester Fabric Followed by an Enzymatic Clearing Process (MtL/MeS System)

The dyeing process was carried out as described in Example 1. The afterclearing process was conducted as follows:

Filling with 5 mM phosphate buffer (pH 7); 20 mL/g fabric.

Raising rinse bath temperature to 60° C.

Addition of 2 mL Novozyme 809 stock (8 LAMU/mL) and 4 mL MeS stock (10 mM-dissolved in methanol).

Rinsing 20 minutes at 60°C.

Draining the rinse liquor.

Novozyme 809 was a liquid preparation of recombinant Myceliophthora thermophila laccase (MtL) supplied by Novozymes A/S (produced as described in WO 92/16634). MeS was Methyl Syringate supplied by Lancaster.

The fabric was squeezed and dried. The wash fastness was determined according to AATCC TM 61-2A, 1994. The staining evaluation scores from wash fastness test were found to be 4.5 (silk), 4.0 (Nylon) and 4.0 (Acetate). Calculated K/S values were:

| | |
|---|---|
| K/S value before treatment: | 27.273 |
| K/S value after treatment: | 27.659 |

### Conclusion to Examples 1-3

Both the peroxidase/HOBT system (Example 1) and the laccase/MeS system (Example 3) are excellent alternatives to the conventional chemical reduction clearing (Example 2). Both enzymatic systems showed excellent wash fastness properties without causing undesirable color fading/shade shifting to the dyed fabric.

### Example 4

Removal of Water Insoluble Disperse Dyes with Two Enzyme/Mediator Systems

The dyes tested were:

Disperse Blue 27 (Dorospers Blue GLF from D&G Dyes),

Disperse Red 60 (Dianix Red E-Fb from Dystar L.P.),

Disperse Violet 1 (Akasperse Violet 3R from Aakash Chemicals & Dyestuffs, Inc.),

Disperse Blue 56, (Dianix Blue E-R from Dystar L.P.),

Disperse Blue 3 (Akasperse Blue GLF from Aakash Chemicals & Dyestuffs, Inc.),

Disperse Yellow 3 (Akasperse Yellow G from Aakash Chemicals & Dyestuffs, Inc.).

All dyes were evenly dispersed in 20 mM phosphate buffer (pH 7.0) with the initial absorbance of approximately 0.8 (measured in 1-Butanol) at the wavelength λmax of the maximum absorbance within the visible range. The solution was initially placed in a glass tube in water bath set at 60° C. The components of two enzyme/mediator systems were dosed as follows:

CiP/HOBT/H₂O₂ System

2.4 POXU/mL Coprinus cinereous peroxidase (CiP)

0.4 mM HOBT

0.4 mM H₂O₂

MtL/MeS System

160 LAMU/L Myceliophthora thermophila laccase (MtL)

0.4 mM Methyl Syringate (MeS)

After 10 min, 5 mL 1-butanol were added to the test tube to stop the reaction. The mixture was centrifuged and the dye degradation products were extracted into 1-butanol phase, which was transferred into a thermo-stated quartz curette in a HP 845x UV-vis spectrophotometer for final absorbance measurement. The degree of oxidative removal, i.e. the decrease in ABS (λmax) over 10 min divided by the initial ABS (λmax), is summarized in table 1.

TABLE 1
Oxidative removal of disperse dyes
treated with enzyme/mediator systems.

| | λmax | Structural | CiP/HOBT | MtL/MeS |
|---|---|---|---|---|
| C.I. Name | (nm) | Class | (% removal) | (% removal) |
| Disperse Blue 27 | 610 | Anthraquinone | 88 | 89 |
| Disperse Red 60 | 518 | Anthraquinone | 26 | 36 |
| Disperse Violet 1 | 594 | Anthraquinone | 77 | 82 |
| Disperse Blue 56 | 628 | Anthraquinone | 80 | 89 |
| Disperse Blue 3 | 644 | Anthraquinone | 87 | 72 |
| Disperse Yellow 3 | 357 | Monoazo | 58 | 75 |

This example demonstrates that two of the preferred mediators according to this invention, HOBT (1-hydroxybenzotriazole, a derivative of N-hydroxy heterocyclic compounds) combined with Coprinus cinereous peroxidase (CiP) and hydrogen peroxide; and MeS (Methyl Syringate, a derivative of substituted phenol compounds) combined with Myceliophthora thermophila laccase (MtL), provide a high degree of removal of a range of water insoluble disperse dyes.

1. A process for removal of excess disperse dye from a printed or dyed textile material, comprising treatment with a rinse liquor comprising:
at least one enzyme selected from the group consisting of enzymes exhibiting peroxidase activity or laccase activity,
an oxidation agent, and
at least one mediator;
wherein the textile material is a fabric, yarn, fiber, garment or film which comprise at least 20% of a synthetic material.

2. The process of claim 1, wherein the synthetic material is selected from acetate, diacetate, triacetate, polyacrylic, polyamide, polyester, and polyurethane.

3. The process of claim 1, wherein the enzyme is a laccase (EC 1.10.3.2), a catechol oxidase (EC 1.10.3.1), a bilirubin oxidase (EC 1.3.3.5), a peroxidase (EC 1.11.1.7), or a haloperoxidase, such as a chloride peroxidase (EC 1.11.1.10) or any fragment derived therefrom exhibiting enzymatic activity or synthetic or semisynthetic derivatives thereof.

4. The process of claim 3, wherein the peroxidase is derived from a strain of Coprinus or from soybean.

5. The process of claim 3, wherein the laccase is derived from a strain of Fomes, Trametes (Polyporus), Rhizoctonia, Coprinus, Myceliophthora, or Schytalidium.

6. The process of any of claims 1-5, wherein the amount of enzyme is 0.005 to 10 mg enzyme protein per liter of rinse liquor, preferably, 0.02 to 5 mg enzyme protein per liter of rinse liquor, more preferably 0.05 to 2 mg enzyme protein per liter of rinse liquor.

7. The process of any of claims 1-6, wherein the oxidation agent is a H₂O₂ source.

8. The process of claim 7, wherein the H₂O₂ source is hydrogen peroxide, a perborate, a percarbonate, a persulfate, a peroxycarboxylic acid or a salt thereof, or an enzymatic system capable of generating hydrogen peroxide.

9. The process of claim 8, wherein the concentration of H₂O₂ is from 0.01 to 50 mM, preferably 0.1 to 5 mM.

10. The process of any of claims 1-6, wherein the oxidation agent is a O₂ source.

11. The process of claim 10, wherein the O₂ source is air, pure O_{2,} or an O₂ generating enzymatic system.

12. The process of any of claims 1-11, wherein the mediator is a compound of general formula I.

13. The process of claim 12, wherein the mediator is a compound of general formula II.

14. The process of any of claims 1-11, wherein the mediator is a compound of general formula III.

15. The process of any of claims 1-11, wherein the mediator is a compound of general formula IV.

16. The process of claim 15, wherein the mediator is a compound of general formula V.

17. The process of any of claims 1-11, wherein the mediator is a compound of general formula VI.

18. The process of claim 17, wherein the mediator is a compound of general formula VII.

19. The process of any of the preceding claims, wherein the concentration of mediator in the rinse liquor is from 0.1 μM to 50 mM, preferably 0.5 μM to 10 mM, more preferably 1 μM to 1 mM, most preferably 10 μM to 0.5 mM.

20. The process of any of the preceding claims, wherein the additives are surfactants and/or water conditioning agents.

21. Use of components comprising:
at least one enzyme selected from the group consisting of enzymes exhibiting peroxidase activity or laccase activity,
an oxidation agent, and
at least one mediator,
for the preparation of a multi-component system for removal of excess disperse dye or print from a dyed or printed textile material, wherein the textile material is a fabric, yarn, fiber, garment or film which comprise at least 20% of a synthetic material.
